(19) United States
(12) Patent Application Publication
(10) Pub. No.: US 2018/0306216 A1
(43) Pub. Date: Oct. 25, 2018

(54) Flow Conditioners for Use Normalizing Flow in Meters and Related Systems

(71) Applicant: Sensus Spectrum, LLC, Morrisville, NC (US)

(72) Inventor: Christian Heizenroeder, Durham, NC (US)

(21) Appl. No.: 15/494,902

(22) Filed: Apr. 24, 2017

(51) Int. Cl. F15D 1/00; G01F 1/58

(52) U.S. Cl. CPC F15D 1/0025; G01F 1/58

(57) ABSTRACT

Flow conditioners are provided including a face having at a plurality of openings therein and an elongated body coupled to the face, each of the plurality of openings having a corresponding shaft on the elongated body. The flow conditioner is configured to be positioned in a meter such that water flows into the meter through the plurality of openings in the face of the flow conditioner and through the corresponding shafts on the elongated body to condition the flow through the meter. The presence of the flow conditioner in the meter improves a measured flow rate at flow rates less than 1.0 gallon per minute (GPM). Related systems are also provided.

### FIELD

The present inventive concept relates generally to water meters and, more particularly, to performance testing of magnetic inductive water meters and related systems.

### BACKGROUND

Marketing and commercialization of products typically requires details about performance of the product. Customers decide to buy products based on these details. If the product fails to perform as promised, the customer is not satisfied and it reflects poorly on the company offering the product. Thus, it is important that the product perform as promised when customers perform acceptance tests.

For example, when meters, for example, water meters, gas meters, electric meters and the like are sold, customers usually buy them in bulk. Thus, rather than test them one at a time they are tested in groups. In particular, common utilities may use test benches where multiple meters are strung together and tested in series. If the meters don't pass the acceptance test, the meters may be shipped back to the supplier. Thus, improved methods of testing meters are desired.

### SUMMARY

Some embodiments of the present inventive concept provide flow conditioners including a face having at a plurality of openings therein and an elongated body coupled to the face, each of the plurality of openings having a corresponding shaft on the elongated body. The flow conditioner is configured to be positioned in a water meters inlet such that one of water flows into the meter through the plurality of openings in the face of the flow conditioner and through the corresponding shafts on the elongated body to condition the flow through the meter. The presence of the flow conditioner in the meter generally improves the performance, for example, the accuracy, precision and repeatability, at flow rates less than 1.0 gallon per minute (GPM).

In further embodiments, the flow conditioner may be positioned in one of a plurality of meters coupled together in series and a presence of the flow conditioner in the meter may improve a measured flow rate through the plurality of meters at flow rates less than 1.0 gallon per minute (GPM).

In still further embodiments, the flow conditioner may be configured to straighten the flow through the meter.

In some embodiments, the flow conditioner may be configured to create turbulence in the flow through the meter.

In further embodiments, the flow conditioner may be configured to create turbulence and straighten the flow through the meter.

In still further embodiments, a measured flow rate of the meter at less than 1.0 GPM may be improved by from about 0.5 to about 1.0 percent when the flow conditioner is positioned in the meter.

Some embodiments of the present inventive concept provide a flow conditioner positioned in a meter to straighten and/or mix flow of water through the meter such that the presence of the flow conditioner in the meter improves measured performance of the meter at flow rates less than 1.0 gallon per minute (GPM).

In further embodiments, the flow conditioner may be positioned in one of a plurality of meters coupled together in series and presence of the flow conditioner in the meter may improve a measured flow rate through the plurality of meters at flow rates less than 1.0 gallon per minute (GPM).

In still further embodiments, the flow conditioner may be configured to straighten the flow through the meter.

In some embodiments, the flow conditioner may be configured to create turbulence in the flow through the meter.

In further embodiments, the flow conditioner may be configured to create turbulence and straighten the flow through the meter.

In still further embodiments, a measured flow rate of the meter at less than 1.0 GPM may be improved by from about 0.5 to about 1.0 percent when the flow conditioner is positioned in the meter.

In some embodiments, the flow conditioner may include a face having at a plurality of openings therein and an elongated body coupled to the face, each of the plurality of openings having a corresponding shaft on the elongated body. The water may flow into the meter through the plurality of openings in the face of the flow conditioner and through the corresponding shafts on the elongated body to condition the flow through the meter.

Further embodiments of the present inventive concept provide systems for conditioning flow through a plurality of meters. The system includes a plurality of meters coupled together in series at least one flow conditioner positioned in at least one of the plurality of meters, the presence of the at least one flow conditioner in the at least one of the plurality of meters improving measured performance of the plurality of meters at flow rates less than 1.0 gallon per minute (GPM).

### BRIEF DESCRIPTION OF THE DRAWINGS

FIG. 1A is a perspective view of a flow straightener in accordance with some embodiments of the present inventive concept.

FIG. 1B is a perspective view of a flow mixer in accordance with some embodiments of the present inventive concept.

FIG. 2 is a front view of a flow conditioner in accordance with some embodiments of the present inventive concept.

FIG. 3 is a front view of a meter having the flow conditioner positioned therein in accordance with embodiments of the present inventive concept.

FIG. 4 is a perspective view of a meter having the flow conditioner positioned. therein.

FIG. 5 is cross section of a meter having the flow conditioner positioned therein.

FIGS. 6A through 6C are front views of flow conditioners in accordance with various embodiments of the present inventive concept.

FIG. 7 is a block diagram of a series of meters connected together for testing in accordance with some embodiments of the present inventive concept.

FIG. 8 is a graph illustrating performance results where no flow conditioner is positioned in the meters during testing.

FIG. 9 is a graph illustrating performance results where a flow mixer is positioned in the meters during testing.

FIG. 10 is graph illustrating performance when a flow conditioner (straightener) in accordance with some embodiments of the present inventive concept is positioned in the meters.

### DETAILED DESCRIPTION

The present inventive concept will be described more fully hereinafter with reference to the accompanying figures, in which embodiments of the inventive concept are shown. This inventive concept may, however, be embodied in many alternate forms and should not be construed as limited to the embodiments set forth herein.

Accordingly, while the inventive concept is susceptible to various modifications and alternative forms, specific embodiments thereof are shown by way of example in the drawings and will herein be described in detail. It should be understood, however, that there is no intent to limit the inventive concept to the particular forms disclosed, but on the contrary, the inventive concept is to cover all modifications, equivalents, and alternatives falling within the spirit and scope of the inventive concept as defined by the claims. Like numbers refer to like elements throughout the description of the figures.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein the term “and/or” includes any and all combinations of one or more of the associated listed items and may be abbreviated as “/”.

Unless otherwise defined, all terms (including technical and scientific terms) used herein have the same meaning as commonly understood by one of ordinary skill in the art to which this inventive concept belongs. It will be further understood that terms used herein should be interpreted as having a meaning that is consistent with their meaning in the context of this specification and the relevant art and will not be interpreted in an idealized or overly formal sense unless expressly so defined herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

As discussed in the background, performance of products during acceptance testing by the customer is very important for both customer satisfaction and retention. It has been observed that during performance testing of particular products, for example, water meters, accuracy and metrology performance is not consistent for both low and high flows. For example, it has been observed that some meters have a substantially zero percent error rate at 15 gallons per minute (GPM) (medium-high flow), but will have a one percent error rate at 0.11-0.18 GPM (low flow). The discrepancy in performance appears to be more pronounced when testing multiple meters in line. On test benches, for example, water meter test benches, used by customers such as common utilities, multiple meters are tested in series. Thus, when acceptance tests are performed by the customers upon receipt, the degradation in performance during low flow would likely be observed. If the customer finds that the product is not compliant with promised performance, they may ship the product back and/or provide negative feedback.

Manufactures of commercially used high accuracy inductive magnetic flow meters, such as Endress+Hauser and ABB, suggest grounding a flow meter before and after the meter to reduce the likelihood of performance issues during testing, but this method has not provided the desired results. In particular, this method has not proven effective on meters having ultra-low power and very small signals. Most magnetic inductive flow meters are powered by a power supply. For example, a residential water meter typically lasts 20 years on a battery. Thus, improved methods of performance testing are desired.

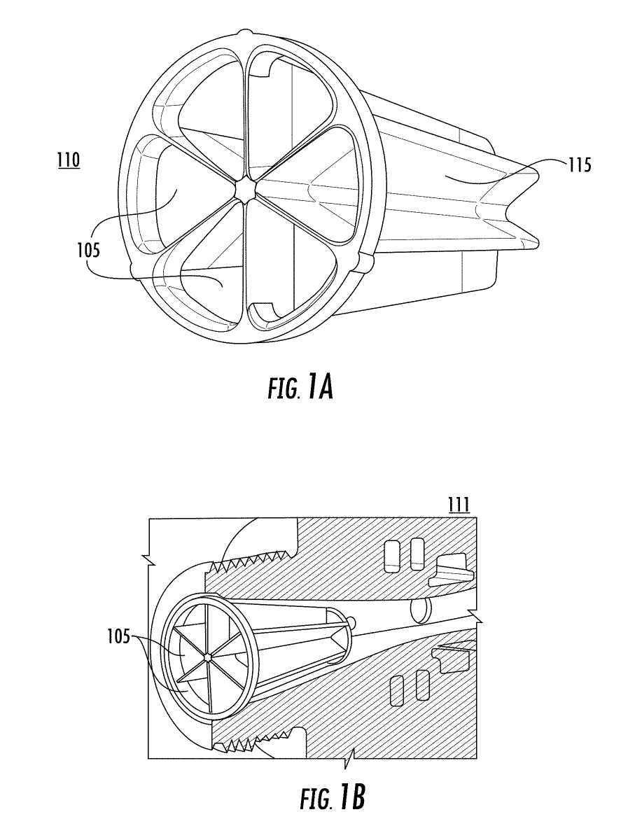

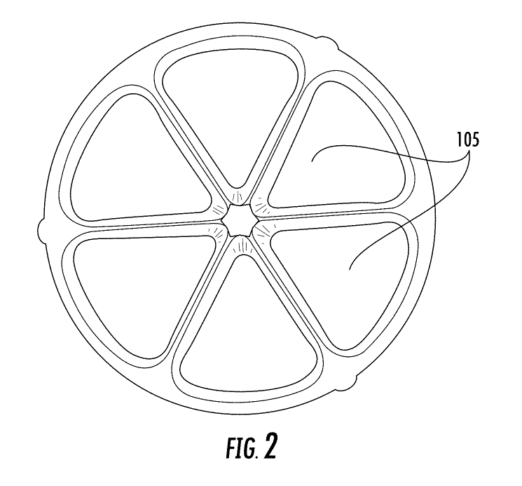

Accordingly, some embodiments of the present inventive concept provide devices for, mixing and/or straightening the flow through the meters that correct the drop in accuracy at low flows in the performance results. Thus, embodiments of the present inventive concept may improve the metrology performance of meters, especially when multiple meters are tested in series as will be discussed further below with respect to FIGS. 1A through 10.

As used herein, the term “flow conditioner” refers to an object that is positioned into the flow of a meter, for example, a water meter, that causes the flow to be straightened, mixed and/or disturbed. The flow conditioner may be placed in an inlet of the meter as will be discussed herein. Generally, it has been observed that a flow straightener provides better results than a mixer, however, both have a significant impact on performance results. Accuracy of flow meters may be affected by many variables, for example, meters may be sensitive to vibrations in the pipe; water hammer; waves induced by pumps or other machinery; and testing multiple meters in series (typically done in the factory or at customer test site).

Adding a flow conditioner in accordance with embodiments of the present inventive concept to a residential meter, for example, a magnetic (MAG) flow meter or Ultrasonic meter, provides improved performance when subject to one or more of the variables discussed above. Without use of a flow conditioner, either one inducing turbulence or one providing a more laminar flow, the piping upstream and downstream of the meter to determine the flow profile. Using a flow conditioner in accordance with embodiments discussed herein, whether inducing laminar or turbulent flow, allows the flow profile to be controlled and, therefore, is predicable.

Referring first to FIGS. 1A and 1B, perspective views of flow conditioners in accordance with some embodiments of the present inventive concept will be discussed. In particular, FIG. 1A illustrates a flow straightener 110 and FIG. 1B illustrates a flow mixer. Although the flow conditioner is discussed herein primarily with respect to the flow straightener 110 of FIG. 1A, embodiments of the present inventive concept are not limited to this configuration.

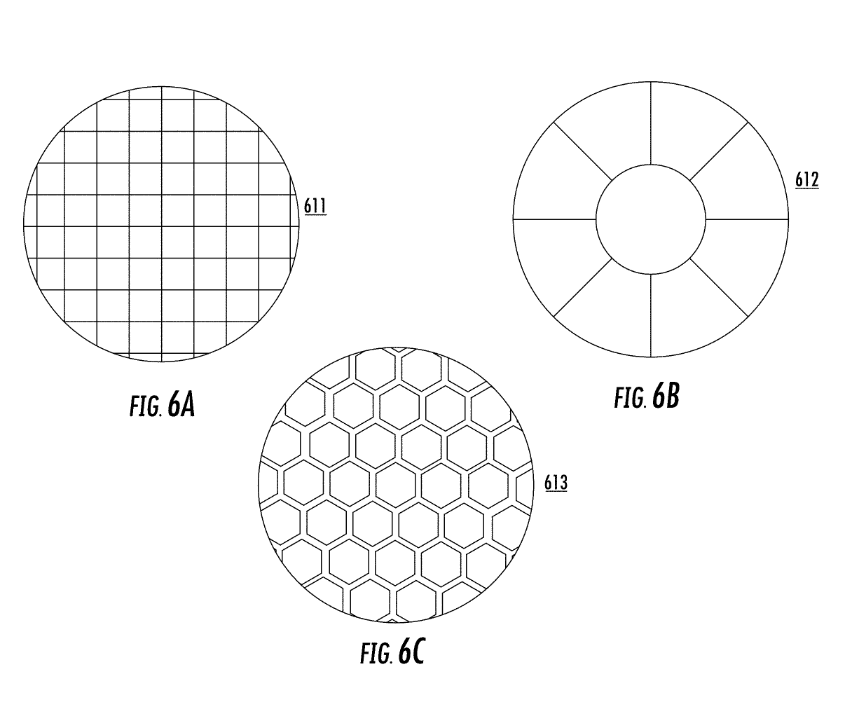

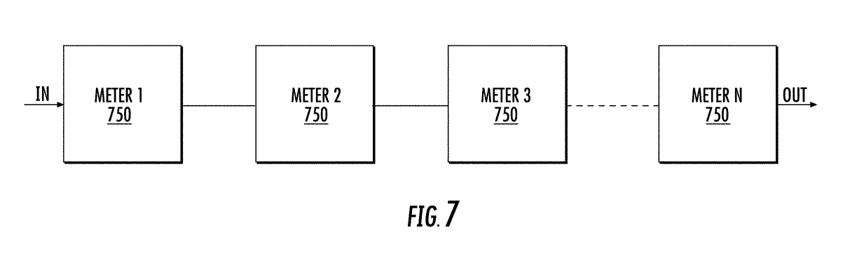

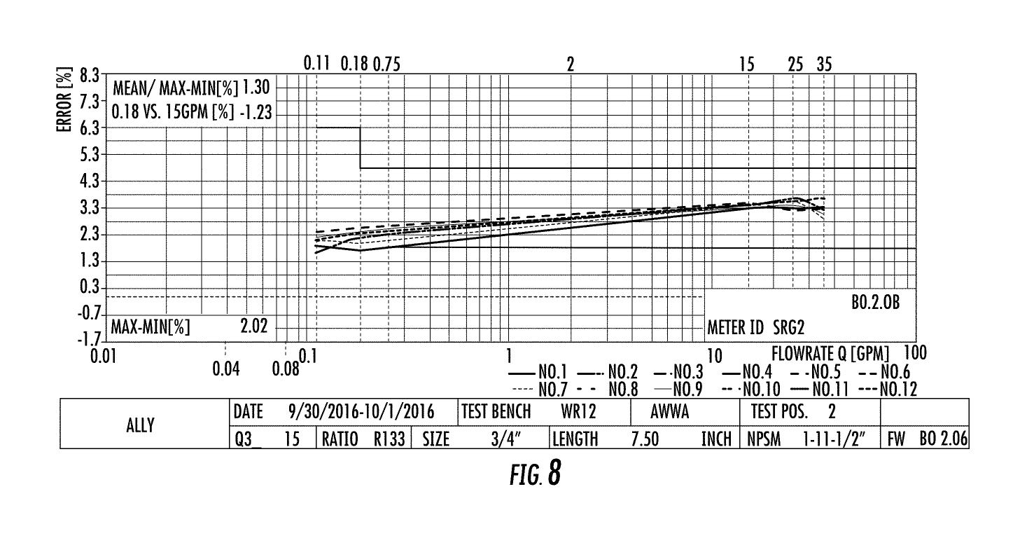

Referring now to FIG. 1A, the flow conditioner 110 includes a series of openings 105 that lead to a corresponding series of shafts through a body 115 of the flow conditioner 110. Although the flow conditioner 110 is shown having a plurality (six) pie shaped openings 105 (FIG. 2), it will be understood that embodiments of the present inventive concept are not limited to this configuration. There may be more or less than six openings and any shape can be utilized without departing from the scope of the present inventive concept. For example, various patterns for flow conditioners 110 are illustrated in FIGS. 6A through 6C.

In particular, FIG. 6A illustrates a flow conditioner 611 having a grid shaped pattern; FIG. 6B illustrates a flow conditioner 612 having a circular center with similar sized openings surrounding the center; and FIG. 6C illustrates a flow conditioner 613 having a series of small circular openings. The flow conditioners of FIGS. 6A through 6C are provided for example only and are not intended to limit the inventive concept.

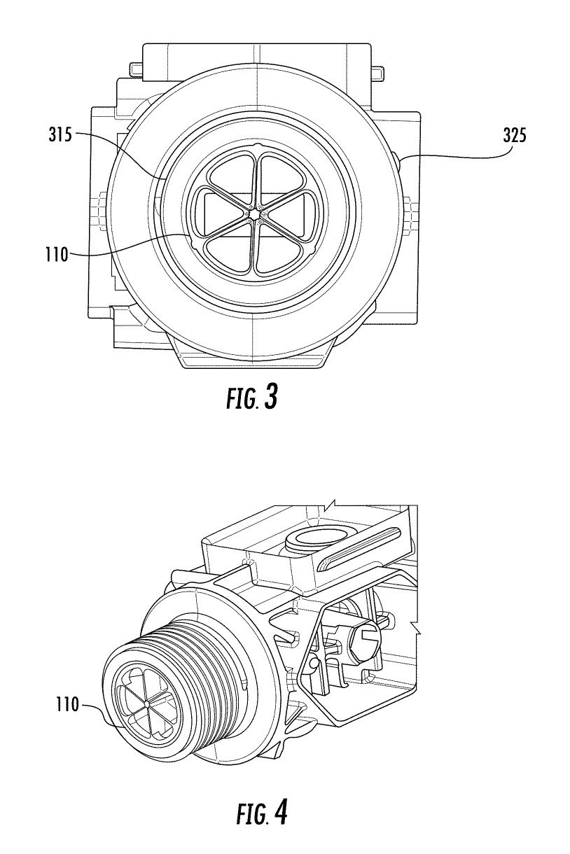

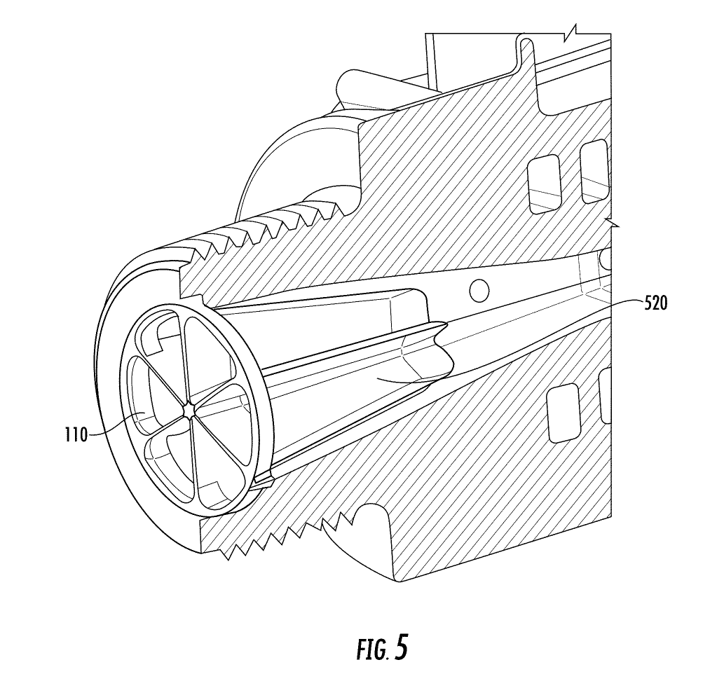

Referring again to FIG. 1A, the physical size of the flow conditioner 110 will vary based on the size of the meter to which it corresponds. FIGS. 3 through 5 illustrate a flow conditioner 110 positioned in a meters inlet in accordance with some embodiments of the present inventive concept. As illustrated in FIGS. 3 and 4, the flow conditioner 110 fills the cross section of the tube 315 entering the meter 325. Thus, in embodiments of a water meter, the water is forced to flow through the openings 105 and through the shafts 115 of the flow conditioner to provide straightening (or turbulence—FIG. 1B) of the flow. As illustrated in FIG. 5, the flow conditioner 110 is configured to taper to be received by the tapered tube 520 of the meter.

Flow conditioners 110 in accordance with embodiments of the present inventive concept may be made of any material capable of providing the necessary function. For example, in some embodiments the flow conditioner may be a hard plastic material. However, in other embodiments, the material may be metal, graphite, and the like without departing from the scope of the present inventive concept.

As discussed above, the flow conditioner 115 may be used to normalize the flow through the meter so that the flow is predictable and the meter performs as predicted. The flow conditioner 110 can be used when testing one or more meters to change the flow-profile before measuring the flow/volume. However, it has been observed that the flow measurements are more distorted if more than one meter is tested at the same time, for example, multiple meters connected together in series on a test bench. In some embodiments, ten or more meters may be connected in series and if the flow profile of all ten does not meet the quoted performance parameters, the customer will not be satisfied.

Referring now to FIG. 7, a block diagram illustrating multiple meters 1 to N (750) connected together in series. In some embodiments, a flow conditioner 110 may be inserted into the meter tube at the inlet (IN). Flow may be measured at any point in the series of meters and more than one flow conditioner may be used without departing from a scope of the present inventive concept.

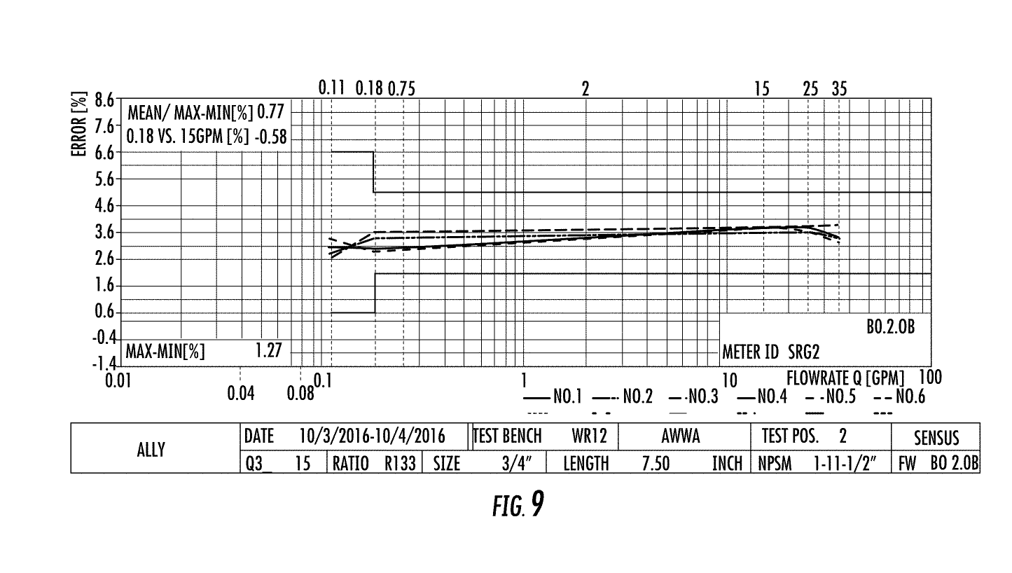

Example results will now be discussed with respect to FIGS. 8 through 10. Referring first to FIG. 8, test results for a system that does not use a flow conditioner in accordance with embodiments discussed herein will be discussed. A five point accuracy test was performed. The x axis illustrates flow rate and the y-axis illustrates error rate in percentage. As illustrated in FIG. 8, flow rate was measured through 10 meters connected in series and a drop in accuracy in the flow rate was −1.23 percent. As illustrated, the whole curve drops at the low flow rates (left hand side of the graph). Ideally the graph should illustrate a perfectly horizontal line.

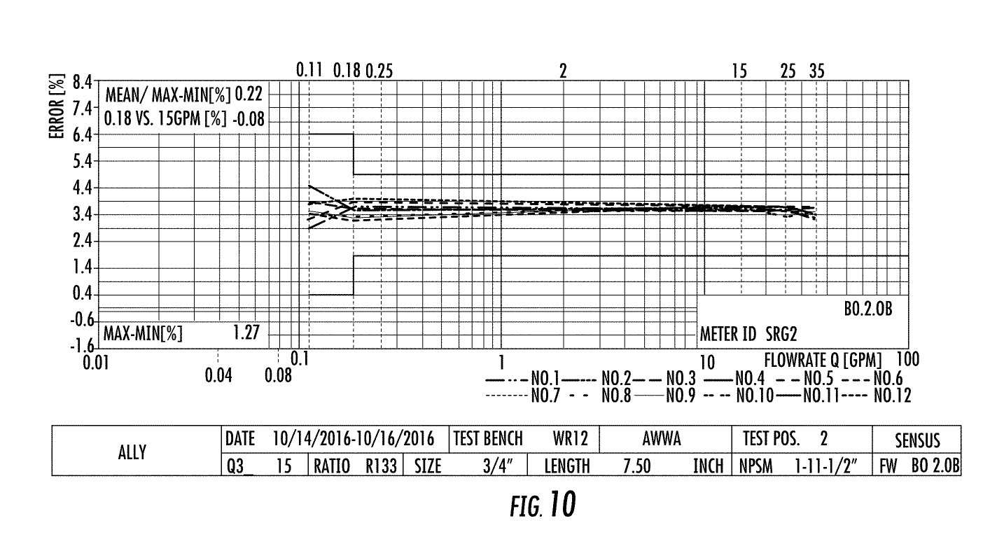

In FIG. 9, a flow strainer that causes minor turbulence was positioned in each meter in the series of meters and a drop in accuracy in the flow rate was now only −0.58 percent. Thus, placement of the flow strainer improved performance by more than half.

Finally, a flow conditioner in accordance with embodiments discussed herein was inserted in the first meter in the series of meters and a drop in accuracy in the flow rate from 15 GPM to 0.18 GPM was only −0.08 percent as shown in FIG. 10. Thus, placement of the flow conditioner caused the meters connected in series to perform almost ideally. As illustrated, the line illustrated in FIG. 10 is almost horizontal. Thus, according to embodiments discussed herein, introducing either turbulence to the flow or straightening the flow may provide improved performance results when flow is measured across a plurality of meters. However, improvement in performance tests for a single meter including the flow conditioner at low flow rates has also been observed.

As discussed briefly above, adding components/features close to the inlet of a meter, for example, a residential or commercial magnetive-inductive water meter to change the flow-profile before starting measuring the flow/volume has provided more favorable test results.

Residential water meters that are not mechanical, for example, magnetic inductive or ultrasonic, are on the rise. In fact, most residential meters will soon have electronics and sensors built in. These sensors are very sensitive to changes and inconsistencies and will be registered. This registration of changes may be misinterpreted in the performance results. This was not a problem with mechanical meters, as they are not sensitive to minor changes. With more competition entering the market and the ease of marketing, accuracy and performance are becoming more and more important. Every single inconsistency in the flow or meter will affect the total outcome of the quality of the product. Accordingly, using a flow conditioner in accordance with embodiments discussed herein while testing meters to ensure performance metrics are met may provide customers with the comfort level needed to maintain the business relationship.

Example embodiments are described above with reference to block diagrams and/or flowchart illustrations of systems and devices. The functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

In the drawings and specification, there have been disclosed exemplary embodiments of the inventive concept. However, many variations and modifications can be made to these embodiments without substantially departing from the principles of the present inventive concept. Accordingly, although specific terms are used, they are used in a generic and descriptive sense only and not for purposes of limitation, the scope of the inventive concept being defined by the following claims.

1. A flow conditioner comprising:
a face having a plurality of openings therein; and
an elongated body coupled to the face, wherein each of the plurality of openings have a corresponding shaft on the elongated body and wherein the elongated body gradually tapers as it extends away from the face,
wherein the flow conditioner is configured to be positioned in an inlet of a meter such that water flows into the meter through the plurality of openings in the face of the flow conditioner and through each of the corresponding shafts on the elongated body to condition flow through the meter; and
wherein presence of the flow conditioner in inlet of the meter improves a measured flow rate at flow rates less than 1.0 gallon per minute (GPM).

2. The flow conditioner of claim 1, wherein the flow conditioner is positioned in an inlet of one of a plurality of meters coupled together in series and wherein presence of the flow conditioner in the inlet of the one of the plurality of meters improves a measured flow rate through all of the plurality of meters at flow rates less than 1.0 gallon per minute (GPM).

3. The flow conditioner of claim 1, wherein the flow conditioner is configured to straighten flow through the meter.

4. The flow conditioner of claim 1, wherein the flow conditioner is configured to create turbulence in flow through the meter.

5. The flow conditioner of claim 1, wherein the flow conditioner is configured to create turbulence and straighten flow through the meter.

6. The flow conditioner of claim 1, wherein a measured flow rate of the meter at less than 1.0 GPM improves by from about 0.5 to about 1.0 percent when the flow conditioner is positioned in the meter.

7. A flow conditioner positioned in an inlet of a first meter in a series of meters to straighten and/or mix flow of water through the series of meters such that a presence of the flow conditioner in the first meter in the series of meters improves measured performance of all meters in the series of meters at flow rates less than 1.0 gallon per minute (GPM).

8. The flow conditioner of claim 7, wherein the series of meters are directly coupled to one another to test performance of all meters in the series of meters.

9. The flow conditioner of claim 7, wherein the flow conditioner is configured to straighten flow through the series of meters.

10. The flow conditioner of claim 7, wherein the flow conditioner is configured to create turbulence in flow through the series of meters.

11. The flow conditioner of claim 7, wherein the flow conditioner is configured to create turbulence and straighten flow through the series of meters.

12. The flow conditioner of claim 7, wherein a measured flow rate at less than 1.0 GPM improves by from about 0.5 to about 1.0 percent when the flow conditioner is positioned in the first meter in the series of meters.

13. The flow conditioner of claim 12, wherein the flow conditioner comprises:
a face having a plurality of openings therein; and
an elongated body coupled to the face, wherein each of the plurality of openings have a corresponding shaft on the elongated body and wherein the elongated body gradually tapers as it extends away from the face,
wherein water flows into the meter through the plurality of openings in the face of the flow conditioner and through each of the corresponding shafts on the elongated body to condition flow through the meter.

14. A system for conditioning flow through a plurality of meters, the system comprising:
a plurality of meters coupled together in series; and
at least one flow conditioner positioned in an inlet of at least one of the plurality of meters, presence of the at least one flow conditioner in the inlet of at least one of the plurality of meters improving measured performance of the plurality of meters at flow rates less than 1.0 gallon per minute (GPM).

15. The system of claim 14, wherein the at least one flow conditioner is configured to straighten flow through the plurality of meters.

16. The system of claim 14, wherein the at least one flow conditioner is configured to create turbulence in flow through the plurality of meters.

17. The system of claim 14, wherein the at least one flow conditioner is configured to create turbulence and straighten flow through the plurality of meters.

18. The system of claim 14, wherein a measured flow rate of the plurality of meters at less than 1.0 GPM improves by from about 0.5 to about 1.0 percent when the at least one flow conditioner is positioned in the at least one meter.

19. The system of claim 14, wherein the at least one flow conditioner comprises:
a face having a plurality of openings therein; and
an elongated body coupled to the face, wherein each of the plurality of openings have a corresponding shaft on the elongated body and wherein the elongated body gradually tapers as it extends away from the face,
wherein water flows into the plurality of meters through the plurality of openings in the face of the at least one flow conditioner and through each of the corresponding shafts on the elongated body to condition flow through the plurality of meters.
